(19) United States
(12) Patent Application Publication
(10) Pub. No.: US 2007/0246904 A1
(43) Pub. Date: Oct. 25, 2007

(54) Torsion-Beam-Type Suspension Apparatus

(76) Inventors: Satoshi Murata, Aichi-ken (JP); Masahiro Ogane, Aichi-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/575,189

(22) PCT Filed: Sep. 12, 2005
(86) PCT No.: PCT/JP05/17204

§ 371 Date: Mar. 13, 2007

(51) Int. Cl. B60G 21/05

(52) U.S. Cl. 280/124.128

(57) ABSTRACT

A torsion-beam-type suspension apparatus includes a torsion beam and left and right trailing arms connected to the axially outer portions of the torsion beam. The left and right trailing arms are composed of a pair of left and right first arms and a pair of left and right second arms. The left and right first arms, which extend along a fore-aft direction of the vehicle, are connected, at respective rear end portions, to the corresponding axially outer portions of the torsion beam, and mounted, at respective front end portions, to a vehicle body so as to be rotatable about a generally horizontal axis. The left and right second arms, which extend along the fore-aft direction of the vehicle, are connected, at respective front end portions, to the corresponding axially outer portions of the torsion beam, and support left and right wheels at respective rear end portions.

### TECHNICAL FIELD

The present invention relates to a torsion-beam-type suspension apparatus which includes a torsion beam and a pair of left and right trailing arms.

### BACKGROUND ART

As disclosed in Japanese Patent Application Laid-Open No. 2000-318420, a conventionally known torsion-beam-type suspension apparatus includes a torsion beam extending in the width direction of a vehicle. Opposite axially outer portions of the torsion beam are bent toward the rear of the vehicle. Arms are provided in the vicinity of the bent portions such that the arms extend toward the front of the vehicle. Thus, the axially outer portions of the torsion beam and the arms form a pair of left and right trailing arms. The torsion beam is mounted to the vehicle body via the arms such that the torsion beam can rotate about a generally horizontal axis, and left and right wheels are mounted to the respective ends of the bent axially outer portions of the torsion beam.

There has also been known a torsion-beam-type suspension apparatus in which axially outer portions of a torsion beam extending in the width direction of a vehicle are bent toward the direction opposite the direction in the above-described conventional suspension apparatus; i.e., are bent toward the front of the vehicle. Arms are provided in the vicinity of the bent portions such that the arms extend toward the rear of the vehicle. Thus, the axially outer portions of the torsion beam and the arms form a pair of left and right trailing arms. The torsion beam is mounted to the vehicle body at the respective ends of the bent axially outer portions thereof such that the torsion beam can rotate about a generally horizontal axis, and left and right wheels are mounted via the respective arms.

In general, in order to make the appearance of a vehicle attractive or improve steering stability, some vehicles of a given model are designed to have a different tread; i.e., distance between the centers of left and right wheels as measured in the width direction of the vehicle. However, the former conventional torsion-beam-type suspension apparatus raises the following problems when the tread of the vehicle is changed. That is, in order to cope with different treads of the vehicle, a plurality of torsion beams having different lengths corresponding to the treads of the vehicle must be prepared. Further, when the length of the torsion beam changes, the mounting positions of the arms to the vehicle body change. Therefore, in order to enable attachment of the arms to the vehicle body, it is necessary to change the mounting positions on the vehicle body to which the arms are mounted, or to prepare a plurality of arms having different shapes corresponding to different treads of the vehicle to thereby enable mounting of the arms at the same mounting positions irrespective of change in the length of the torsion beam.

Meanwhile, in the case of the latter conventional torsion-beam-type suspension apparatus, preparation of a plurality of torsion beams having different lengths is not required for coping with different treads of the vehicle. However, a plurality of arms having different shapes must be prepared for different treads of the vehicle. As described above, in order to produce vehicles which are of the same model but have different treads, torsion beams and arms having different sizes must be prepared for the different treads, which results in an increase in production cost of the suspension apparatus.

### DISCLOSURE OF THE INVENTION

In view of the foregoing, an object of the present invention is to provide a torsion-beam-type suspension apparatus which can cope with change in tread of a vehicle and which can be produced at low cost.

In order to achieve the above object, the present invention provides a torsion-beam-type suspension apparatus which comprises a torsion beam extending in a width direction of a vehicle and having axially outer portions at opposite ends thereof, and a pair of left and right trailing arms connected to the axially outer portions of the torsion beam. The left and right trailing arms are composed of a pair of left and right first arms extending along a fore-aft direction of the vehicle and a pair of left and right second arms extending along the fore-aft direction of the vehicle. The left and right first arms are connected, at respective rear end portions, to the corresponding axially outer portions of the torsion beam, and mounted, at respective front end portions, to a vehicle body so as to be rotatable about a generally horizontal axis. The left and right second arms are connected, at respective front end portions, to the corresponding axially outer portions of the torsion beam, and support left and right wheels at respective rear end portions.

In this case, preferably, at least the axially outer portions of the torsion beam are disposed to extend parallel to an axle axis, and, with respect to the width direction of the vehicle, the respective ends of the axially outer portions are located outside the positions at which the rear end portions of the first arms are connected to the torsion beam and the positions at which the front end portions of the second arms are connected to the torsion beam.

The above-described structure enables vehicles having different treads to be manufactured by connecting the rear end portions of the first arms to the axially outer portions of the torsion beam in a state in which the front end portions of the first arms are positioned at respective mounting positions at which the first arms are mounted to the vehicle body, and connecting the front end portions of the second arms to the axially outer portions of the torsion beam in a state in which the second arms are positioned in accordance with a desired tread of the vehicle. Accordingly, vehicles having different treads can be manufactured by use of a torsion beam of a single type and first and second arms of a single type, and suspension apparatuses can be produced at low cost. The above-described structure enables the suspension apparatus to be applied not only to vehicles of the same model but also to vehicles of different models. In this case, the torsion beam and the first and second arms can be used as common parts, and thus suspension apparatuses can be produced at lower cost.

Another feature of the present invention resides in that a member which constitutes the first arms is made smaller in thickness than a member which constitutes the second arms. In general, the first arms are considered to bear a smaller amount of load stemming from bending as compared with the second arms, and thus the flexural rigidities of the first arms can be set to be lower than those of the second arms. Since different sectional shapes and wall thicknesses can be set for the first arms and the second arms, the weights of the arms can be reduced, while the flexural rigidities of the arms are secured.

Another feature of the present invention resides in that the torsion beam is formed of a cylindrical pipe, and an axially intermediate portion of the pipe is pressed and deformed such that the intermediate portion has a generally U-shaped or V-shaped transverse cross section, and opposite axially outer portions of the pipe have the same circular transverse cross section over a predetermined length from the respective ends.

In this case, because of a difference in cross sectional shape, the axially outer portions of the torsion beam are less likely to torsionally deform, as compared with the axially intermediate portion thereof. Therefore, even when the torsion beam is twisted, the reliable connection between the first and second arms and the torsion beam is maintained, and the required strengths of the connection portions are secured. Further, the axially outer portions of the torsion beam are formed to have the same circular transverse cross section over a predetermined length from the respective ends. Therefore, even when the tread of the vehicle is changed, the first and second arms are connected to the torsion beam through respective contact areas of the constant length. Therefore, at the time of changing the tread of the vehicle, the strengths of the respective connection portions can be easily determined.

Another feature of the present invention resides in that the opposite ends of the torsion beam are closed by plug members. In this case, by virtue of the plug members, cross sectional deformations at the opposite ends of the torsion beam are effectively suppressed, and the torsional rigidities of the opposite ends of the torsion beam can be increased. Thus, the strengths of the connection portions between the first and second arms and the torsion beam can be secured more effectively. Further, the plug members can effectively prevent entry of foreign substances, such as dust and mud, into the interior of the torsion beam.

### BRIEF DESCRIPTION OF THE DRAWINGS

FIG. 1 is a schematic perspective view of a torsion-beam-type suspension apparatus according to an embodiment of the present invention.

FIG. 2 is an enlarged perspective view of the rear right wheel side of the torsion-beam-type suspension apparatus of FIG. 1 as viewed from the front and inner side of the vehicle.

FIG. 3 is an enlarged perspective view of the rear right wheel side of the torsion-beam-type suspension apparatus of FIG. 1 as viewed from the rear and inner side of the vehicle.

FIG. 4 is a plan view of the rear right wheel side of the torsion-beam-type suspension apparatus of FIG. 1.

### BEST MODE FOR CARRYING OUT THE INVENTION

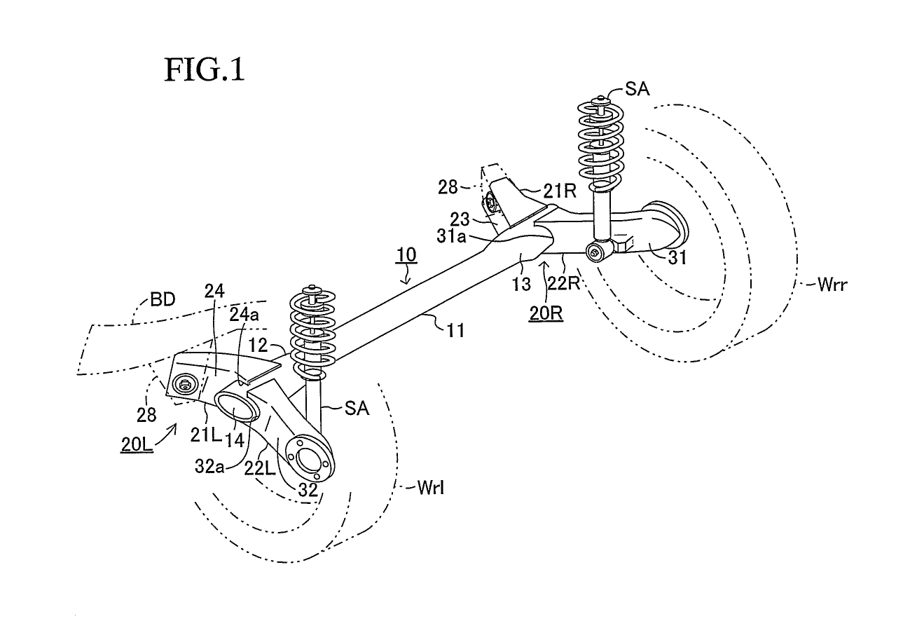

An embodiment of the present invention will now be described with reference to the drawings. FIG. 1 shows the overall structure of a torsion-beam-type suspension apparatus according to the embodiment. The torsion-beam-type suspension apparatus includes a torsion beam 10, and a pair of left and right trailing arms 20L and 20R.

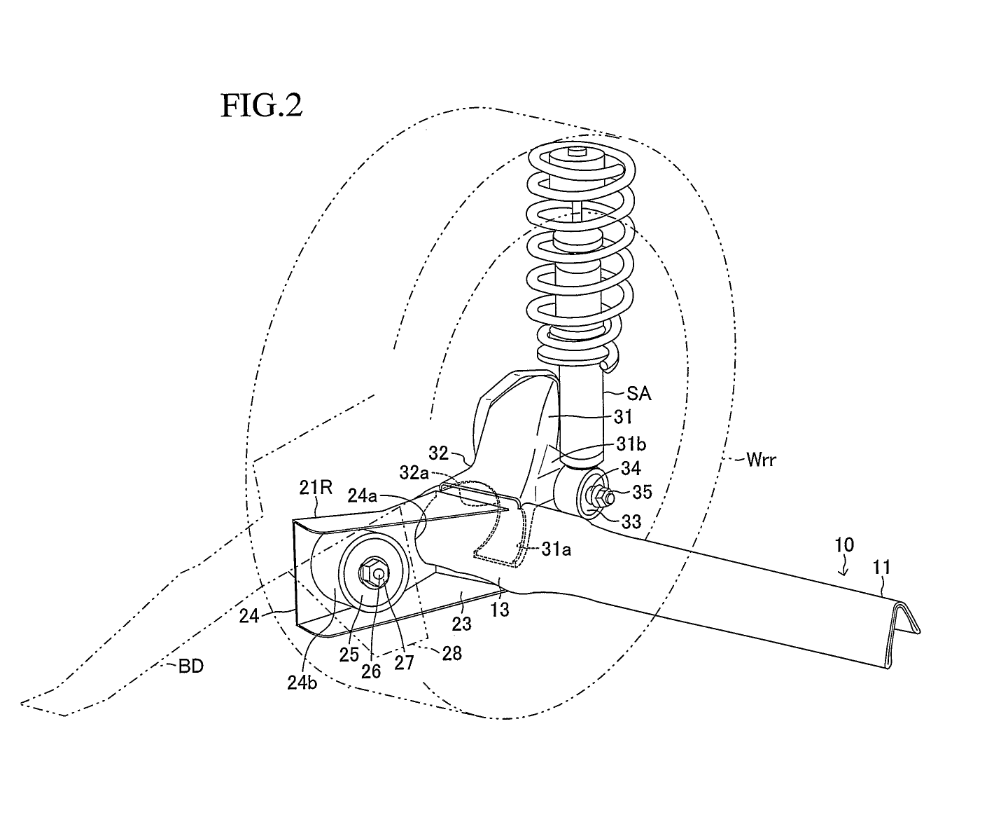

The torsion beam 10 is formed of a cylindrical pipe and extends in the width direction of a vehicle. As shown in FIGS. 1 and 2, an axially intermediate portion 11 of the torsion beam 10 is pressed and deformed to have a generally V-shaped transverse cross section. Opposite axially outer portions 12 and 13 of the torsion beam 10 are formed such that they have the same elliptical cross section over a predetermined length from the respective ends. The axially outer portions 12 and 13 extend parallel to the axle axis, which is the center axis about which left and right rear wheels Wrl and Wrr rotate.

The opposite ends of the torsion beam 10 are closed with plug members 14. The plug members 14 are formed of elliptical plate members which come into contact with the inner circumferential surfaces of the opposite ends of the torsion beam 10, and are fixed to the inner circumferential surfaces by means of, for example, welding. The torsion beam 10 is connected to the left and right trailing arms 20L and 20R via the axially outer portions 12 and 13.

The trailing arm 20L is composed of first and second arms 21L and 22L, and the trailing arm 20R is composed of first and second arms 21R and 22R. Since the left and right trailing arms 20L and 20R are configured in the same manner, only the first and second arms 21R and 22R of the right-hand trading arm 20R will be described specifically. As to the first and second arms 21L and 22L of the left-hand trailing arm 20L, members identical with the first and second arms 21R and 22R are denoted by the like reference numerals, and a detailed description of the left-hand first and second arms 21L and 22L is omitted.

As shown in FIGS. 1 and 2, the first arm 21R is formed of a bent plate member having a generally U-shaped cross section and a wall thickness slightly smaller than that of the torsion beam 10. The first arm 21R is disposed such that it extends along the fore-aft direction of the vehicle and such that an open portion 23 thereof faces the inner side of the vehicle. A generally U-shaped cut 24a is formed in a rear end portion of a side wall 24 of the first arm 21R such that the cut 24a comes into contact with a front-side portion of the outer circumferential surface of the axially outer portion 13. The first arm 21R is integrally connected to the axially outer portion 13 of the torsion beam 10 by means of, for example, welding in such a manner that the axially outer portion 13 is fitted into the cut 24a of the side wall 24.

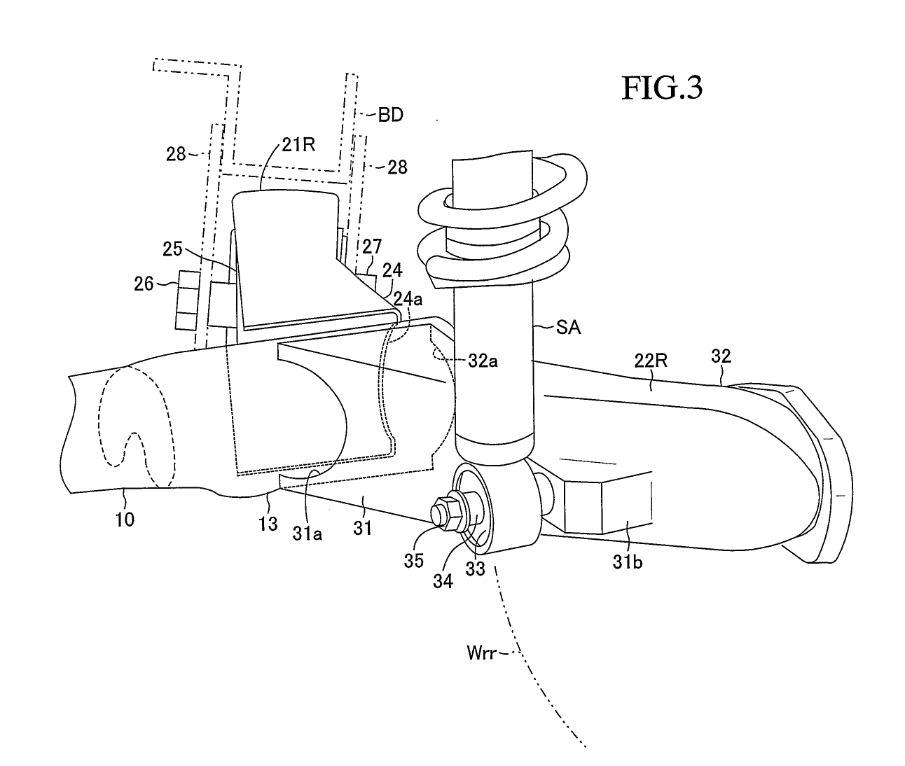

A cylindrical bushing mounting portion 24b is fixed to a front end portion of the side wall 24 of the first arm 21R such that the bushing mounting portion 24b projects toward the open portion 23. A bushing 25 is fitted into the bushing mounting portion 24b. By use of a bolt 26 passing through the bushing 25 and a nut 27, the first arm 21R is mounted to brackets 28 fixed to a portion of the vehicle body BD (e.g., a side member) such that the first arm 21R can rotate about a generally horizontal axis (see FIG. 3).

In this case, the brackets 28 are fixed to predetermined locations on the vehicle body BD irrespective of the tread of the vehicle. Accordingly, the position of connection of the first arm 21R to the torsion beam 10 is constant even when the tread of the vehicle is changed, and the cut 24a of the side wall 24 is located at a position which is offset inboard by a predetermined distance from the end of the axially outer portion 13 of the torsion beam 10.

Notably, the first arm 21R is bent generally horizontally at an intermediate portion of the side wall 24 so as to extend obliquely toward the front, outer side of the vehicle, so that an extension of the axis of the bolt 26 intersects the longitudinal (fore-aft) center line of the vehicle at a position toward the front of the vehicle.

As shown in FIGS. 1 and 3, the second arm 22R is formed as an elongated pipe having a rectangular cross section and a wall thickness generally equal to that of the torsion beam 10, and extends along the fore-aft direction of the vehicle. Generally U-shaped cuts 31a and 32a are formed in front end portions of inner and outer walls 31 and 32 of the second arm 22R such that the cuts 31a and 32a come into contact with a rear-side portion of the outer circumferential surface of the axially outer portion 13 of the torsion beam 10. The second arm 22R is integrally connected to the axially outer portion 13 of the torsion beam 10 by means of, for example, welding in such a manner that the axially outer portion 13 is fitted into the cuts 31a and 32a of the inner and outer walls 31 and 32.

In this case, when the tread of the vehicle is set to the maximum width, the cut 32a of the outer wall 32 is located at a position which is offset inboard by a predetermined distance from the end of the axially outer portion 13 of the torsion beam 10. That is, the torsion beam 10 has a length such that even when the tread of the vehicle is set to the maximum width, the contact between the cut 32a of the outer wall 32 and the axially outer portion 13 is maintained.

The second arm 22R has a front end portion, and a rear end portion which extends horizontally from the front end portion in an oblique direction toward the rear, outer side of the vehicle. A rear right wheel Wrr is attached to the rear portion via an unillustrated spindle. A shock absorber mounting portion 31b is formed at an intermediate portion of the inner wall 31 of the second arm 22R such that it projects toward the inside of the vehicle. A lower end portion of a shock absorber SA is rotatably mounted to the shock absorber mounting portion 31b via a bushing 33, a stepped bolt 34, and a nut 35.

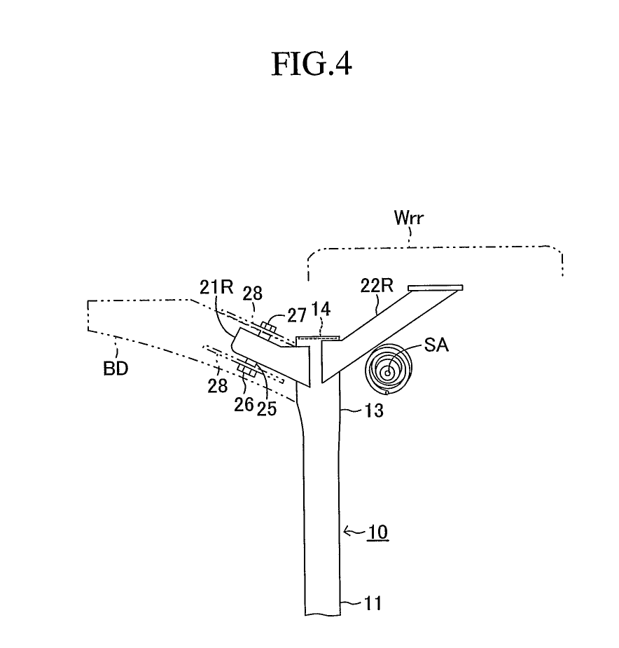

In the embodiment configured as described above, as shown in FIGS. 3 and 4, the first arm 21R is positioned at a predetermined location where the bushing 25 fitted into the front end portion of the first arm 21R can be mounted to the brackets 28 of the vehicle body BD. In this state, the side wall 24 of the first arm 21R is connected to the axially outer portion 13 of the torsion beam 10 along the cut 24a of the side wall 24. Further, the second arm 22R is positioned at a location corresponding to the tread of the vehicle. In this state, the inner and outer side walls 31 and 32 of the second arm 22R are connected to the axially outer portion 13 of the torsion beam 10 along the cuts 31a and 32a of the side walls 31 and 32. In the same manner as for the first and second arms 21R and 22R, the first and second arms 21L and 22L are connected to the axially outer portion 12 of the torsion beam 10.

The above-described structure enables production of vehicles which are of the same model but have different treads, by use of the torsion beam 10 of a single type, the first arms 21L and 21R of a single type, and the second arms 22L and 22R of a single type, to thereby enable low-cost production of suspension apparatuses. In the present embodiment, it is not necessary to change the mounting positions of the first arms 21L and 21R to the vehicle body BD; i.e., the fixation positions of the brackets 28 to the vehicle body BD, in accordance with the tread of the vehicle. Therefore, the number of types of vehicle bodies BD for the same model is not required to be increased.

Meanwhile, the suspension apparatus of the present embodiment can be applied not only to different vehicles of the same model, but also to vehicles of different models in which the first arms 21L and 21R are mounted to the vehicle body BD at different mounting positions. In this case, in accordance with the mounting positions of the first arms 21L and 21R to the vehicle body BD, the connection positions of the first arms 21L and 21R to the torsion beam 10 are changed. This enables the torsion beam 10 and the first and second arms 21L, 22L, 21R, and 22R to be used as common parts, to thereby further lower the production cost of the suspension apparatus.

In the above-described embodiment, the first arms 21L and 21R are formed to have a generally U-shaped cross section, and the plate members which constitute the first arms 21L and 21R are made smaller in thickness than the pipes which constitute the second arms 22L and 22R. This is because, in general, the first arms 21L and 21R bear a smaller amount of load stemming from bending as compared with the second arms 22L and 22R, and thus the flexural rigidities of the first arms 21L and 21R can be set to be lower than those of the second arms 22L and 22R. Since different sectional shapes and wall thicknesses can be set for the first arms 21L and 21R and the second arms 22L and 22R, the weights of the arms can be reduced, while the flexural rigidities of the arms are secured.

In the above-described embodiment, because of a difference in cross sectional shape, the axially outer portions 12 and 13 of the torsion beam 10 are less likely to deform torsionally, as compared with the axially intermediate portion 11 thereof. Therefore, even when the torsion beam 10 is twisted, it is possible to maintain the reliable connection between the first and second arms 21L, 22L, 21R, and 22R and the axially outer portions 12 and 13 of the torsion beam 10, so that the required strengths of the connection portions are secured.

In the above-described embodiment, the opposite ends of the torsion beam 10 are closed by the plug members 14. Accordingly, by virtue of the plug members 14, cross sectional deformations at the opposite ends of the torsion beam 10 are effectively suppressed, and the torsional rigidities of the opposite ends of the torsion beam 10 can be increased. Thus, the strengths of the connection portions between the first and second arms 21L, 22L, 21R, and 22R and the axially outer portions 12 and 13 of the torsion beam 10 can be secured more effectively. Further, the plug members 14 can effectively prevent entry of foreign substances, such as dust and mud, into the interior of the torsion beam 10.

In the above-described embodiment, the first arms 21L and 21R are connected to the axially outer portions 12 and 13 of the torsion beam 10 through respective contact areas of constant length, irrespective of the tread of the vehicle. Further, as in the case of the first arms 21L and 21R, the second arms 22L and 22R are connected to the axially outer portions 12 and 13 of the torsion beam 10 through respective contact areas of the constant length irrespective of the tread of the vehicle. Therefore, at the time of changing the tread of the vehicle, the strengths of the respective connection portions can be easily determined.

In the above, one embodiment of the present invention has been described. However, the present invention is not limited to the embodiment and may be practiced in various modified forms without departing from the scope of the present invention.

In the above-described embodiment, the first arms 21L and 21R are formed of a plate member having a generally U-shaped cross section. However, instead of such a plate member, a pipe member having a closed cross sectional shape may be used. In the above-described embodiment, the second arms 22L and 22R are formed of a pipe member having a rectangular cross section. However, instead of such a pipe member, a plate member having an open cross sectional shape may be used. In the above-described embodiment, the torsion beam 10 is formed of a cylindrical pipe member. However, the torsion beam 10 may be formed of an elongated plate member having a generally U-shaped or V-shaped transverse cross section.

1-5. (canceled)

6: A torsion-beam-type suspension apparatus comprising:
a torsion beam extending in a width direction of a vehicle and having axially outer portions at opposite ends thereof; and
a pair of left and right trailing arms connected to the axially outer portions of the torsion beam,
wherein the left and right trailing arms include a pair of left and right first arms extending along a fore-aft direction of the vehicle and a pair of left and right second arms extending along the fore-aft direction of the vehicle;
the left and right first arms are connected, at respective rear end portions, to the corresponding axially outer portions of the torsion beam, and mounted, at respective front end portions, to a vehicle body so as to be rotatable about a generally horizontal axis, and the left and right second arms are connected, at respective front end portions, to the corresponding axially outer portions of the torsion beam, and support left and right wheels at respective rear end portions.

7: A torsion-beam-type suspension apparatus according to claim 6, wherein at least the axially outer portions of the torsion beam are disposed to extend parallel to an axle axis, and, with respect to the width direction of the vehicle, the respective ends of the axially outer portions are located outside the portions at which the rear end portions of the first arms are connected to the torsion beam and the positions at which the front end portions of the second arms are connected to the torsion beam.

8: A torsion-beam-type suspension apparatus according to claim 7, wherein a member that constitutes the first arms is made smaller in thickness than a member that constitutes the second arms.

9: A torsion-beam-type suspension apparatus according to claim 8, wherein the torsion beam is formed of a cylindrical pipe, and an axially intermediate portion of the pipe is pressed and deformed such that the intermediate portion has a generally U-shaped or V-shaped transverse cross section, and opposite axially outer portions of the pipe have the same circular transverse cross section over a predetermined length from the respective ends.

10: A torsion-beam-type suspension apparatus according to claim 9, wherein the opposite ends of the torsion beam are closed by plug members.

11: A torsion-beam-type suspension apparatus according to claim 6, wherein a member that constitutes the first arms is made smaller in thickness than a member that constitutes the second arms.

12: A torsion-beam-type suspension apparatus according to claim 11, wherein the torsion beam is formed of a cylindrical pipe, and an axially intermediate portion of the pipe is pressed and deformed such that the intermediate portion has a generally U-shaped or V-shaped transverse cross section, and opposite axially outer portions of the pipe have the same circular transverse cross section over a predetermined length from the respective ends.

13: A torsion-beam-type suspension apparatus according to claim 12, wherein the opposite ends of the torsion beam are closed by plug members.

14: A torsion-beam-type suspension apparatus according to claim 6, wherein the torsion beam is formed of a cylindrical pipe, and an axially intermediate portion of the pipe is pressed and deformed such that the intermediate portion has a generally U-shaped or V-shaped transverse cross section, and opposite axially outer portions of the pipe have the same circular transverse cross section over a predetermined length from the respective ends.

15: A torsion-beam-type suspension apparatus according to claim 14, wherein the opposite ends of the torsion beam are closed by plug members.

16: A torsion-beam-type suspension apparatus according to claim 7, wherein the torsion beam is formed of a cylindrical pipe, and an axially intermediate portion of the pipe is pressed and deformed such that the intermediate portion has a generally U-shaped or V-shaped transverse cross section, and opposite axially outer portions of the pipe have the same circular transverse cross section over a predetermined length from the respective ends.

17: A torsion-beam-type suspension apparatus according to claim 16, wherein the opposite ends of the torsion beam are closed by plug members.
